(19) United States
(12) Patent Application Publication
(10) Pub. No.: US 2009/0150239 A1
(43) Pub. Date: Jun. 11, 2009

(54) INTERNET BACKGROUND ADVERTISING SERVICE

(76) Inventor: Louis Dorman, Paradise Valley, AZ (US)

Correspondence Address: JENNINGS, STROUSS & SALMON, P.L.C., 201 E. WASHINGTON ST., 11TH FLOOR, PHOENIX, AZ, 85004, US

(21) Appl. No.: 12/235,503

(22) Filed: Sep. 22, 2008

Related U.S. Application Data
(60) Provisional application No. 60/974,407, filed on Sep. 21, 2007.
(60) Provisional application No. 61/054,747, filed on May 20, 2008.

(51) Int. Cl. G06Q 30/00; G06Q 90/00

(52) U.S. Cl. 705/14; 705/1

(57) ABSTRACT

The present examples provide for a background advertisement service that automates the advertising process. The background advertisement service efficiently brings advertisers and website publishers together. Advertisements may be placed in a pool and made available in various formats, and other advertiser defined criteria. A publisher may select advertisement in any of a variety of formats, typically as one or more styles of background advertisements. The background advertisements may also be combined with one or more banner advertisements to reinforce the background advertisement. The background advertisement service generates code for inclusion into a website publisher's site so that reprogramming or reformatting may not have to be performed. The code generated may be according to the web publisher's specifications, and done through a web interface. Advertising metrics may also be collected for use by the website publisher and the advertiser.

### CROSS-REFERENCE TO RELATED APPLICATIONS

This application claims the benefit of U.S. Provisional Patent Application No. 60/974,407 filed Sep. 21, 2007, the contents of which are hereby incorporated by reference. This application also claims the benefit of U.S. Provisional Patent Application No. 61/054,747 filed May 20, 2008, the contents of which are hereby incorporated by reference.

### TECHNICAL FIELD

This description relates generally to advertising and more specifically to Internet advertising.

### BACKGROUND

Advertising can allow publishers to collect revenue above that made from simply selling a subscription to a customer. Advertising allows the publisher to reduce the cost of the publication, which tends to increase circulation. Advertisers in newspapers can often target advertisements (“ads”) by requesting placement In certain sections of the news. For example tire advertisements may often be placed in the sports section.

The success of print advertisements may also be hard to determine. If an advertiser does not receive increased business he may assume the advertisement (“ad”) may not be seen by potential customers and pull it from the publication, while the real reason may be the price of the goods or some other factor.

Advertisement is often present on the internet. And as the internet has gained in popularity the presence of advertising has tended to increase as advertisers recognize that a large number of potential customers may be reached with their advertisement. Advertisements often appear along side of web content displayed on a browser. Such advertisement often appears in a box, like a billboard, or typical newspaper, or magazine advertisement dispersed within a column of text or at the periphery of the paper page. These internet billboards may blink or spontaneously expand to cover the screen, which many Internet users find obnoxious. This has lead to the development of a number of pop-up blocking solutions. It may be desirable to produce a type of advertising that makes itself known but in a more subtle fashion. The billboards are also of somewhat fixed size and are configured to fit in an available space like a puzzle piece. Supplying an advertisement in nonstandard formats may call for a telephone or personal interaction in order to change the size of the advertisement.

### SUMMARY

The following presents a simplified summary of the disclosure in order to provide a basic understanding to the reader. This summary is not an extensive overview of the disclosure and it does not identify key/critical elements of the invention or delineate the scope of the Invention. Its sole purpose is to present some concepts disclosed herein in a simplified form as a prelude to the more detailed description that is presented later.

The present examples provide for a background advertisement service that automates the advertising process. The background advertisement service efficiently brings advertisers and website publishers together. Advertisements may be placed In a pool and made available in various formats, and other advertiser defined criteria. A publisher may select advertisement in any of a variety of formats, typically as one or more styles of background advertisements. The background advertisements may also be combined with one or more banner advertisements to reinforce the background advertisement. The background advertisement service generates code for inclusion into a website publisher's site so that reprogramming or reformatting may not have to be performed. The code generated may be according to the web publishers specifications, and done through a web interface. Advertising metrics may also be collected for use by the website publisher and the advertiser.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram showing a background advertisement service.

FIG. 2 is a block diagram showing further details of the background advertising service.

FIG. 3 is a flow diagram of a method of creating a background advertisement campaign.

FIG. 4 is a flow diagram of a process for website publishers to create an advertising campaign.

FIG. 5 is an exemplary user interface showing the create campaign tab of the background advertisement service webpage that allows for the setup of the background advertisement.

FIG. 6 is the diagram showing an exemplary background advertisement user interface in a tiled background advertisement format.

FIG. 7 is the flow diagram showing a process of creation of the tiled background advertisement.

FIG. 8 is the diagram showing an exemplary background advertisement user interface of a pillar background advertisement format.

FIG. 9 is the flow diagram showing a process of the creation of the pillar background advertisement.

FIG. 10 is a diagram showing an exemplary background advertisement user interface of the projection background advertisement format.

FIG. 11 is a flow diagram showing a process of the creation of the projection background advertisement.

FIG. 12 is a-diagram showing an exemplary background advertisement user interface for the display of the movie/animation or rich media background advertisement format.

FIG. 13 is a flow diagram showing a process of the creation of the movie/animation or rich media background advertisement.

FIG. 14 is a diagram showing an exemplary background advertisement user interface for the display of the overlay background advertisement format.

FIG. 15 is a flow diagram showing a process of the creation of the overlay background advertisement.

FIG. 16 is a flow diagram of the Advertisers Create Campaign page 600 in the web interface.

FIG. 17 is a diagram of the exemplary unique website publisher javascript code.

FIG. 18 is an exemplary network suitable for implementing a background advertisement service.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a background advertisement service. Although the present examples are described and illustrated herein as being implemented in a networked computer system, the system described is provided as an example and not a limitation. As those skilled in the art will appreciate, the present examples are suitable for application In a variety of different types of computer based consumer electronics systems.

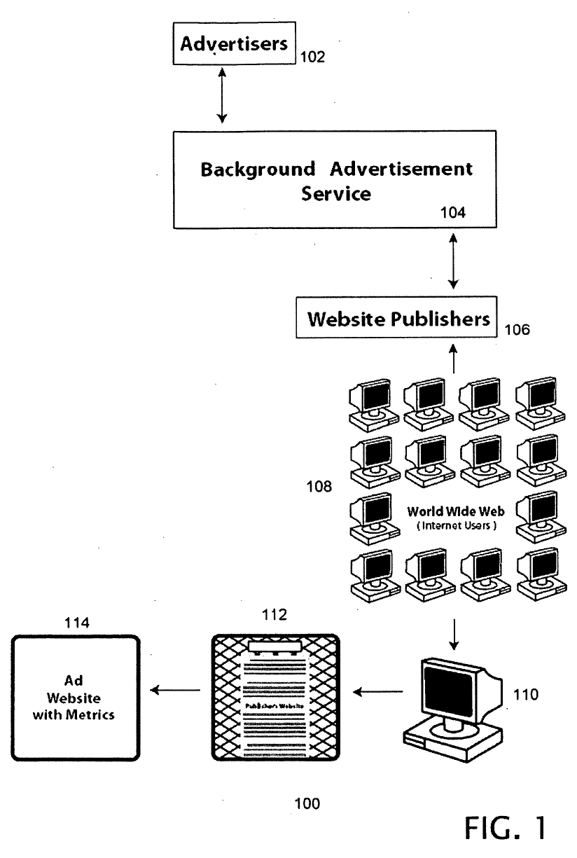

FIG. 1 is a block diagram showing a background advertisement service 100. It shows advertisers and/or website publishers creating a background advertisement then viewing the advertisement on a publisher's website. The system may also include user metrics that may be communicated to the publisher and/or advertiser.

The diagram shows the background advertisement service that combines the function of both, advertisers, or website publishers to create a background advertisement. Once created the background advertisement can be stored on servers of the background advertisement service, to be accessed by anyone on the world wide web. Once the background advertisement is viewed by a user on the publishers website the system will accurately store website users metrics or analytic.

As shown, advertisers 102 may access the background advertisement service 104 to create a database, or repository, of advertising information. A website publisher 106 may access the background advertisement service to obtain advertising content from the advertising repository. Advertising content is typically combined with website content. Advertisers and web publishers may access the background advertisement service through the internet, local area networks, wide area networks or the like 108.

The content with background advertisement may be made available via the internet to a plurality of users 110, typically viewing web content through a web browser program, or its equivalent on a computer or equivalent consumer electronic device. The user typically sees a display 112, or user interface, presenting the website publisher's content, possibly one or more banner advertisements and a background advertisement that provides access to an advertisement website 114.

When a user accesses an advertisement metrics may be generated for communication to the advertiser and/or website publisher to provide metrics, revenue to the website publisher and the like.

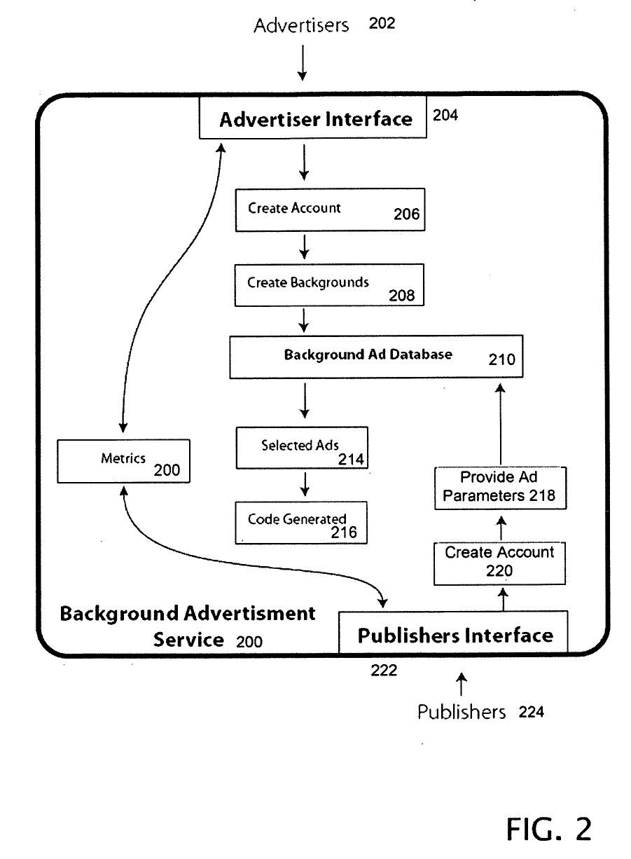

FIG. 2 is a block diagram showing further details of the background advertising service 200. It shows the interaction of one or more advertisers 202 and website publishers 224 in generating the background advertisement being submitting to the background advertisement database for later display as background advertisement when displaying web content. The functional blocks described below may be provided in any one or more coding languages, such as HTML, PHP, ASP.NET, AJAX, CSS or the like.

The diagram shows the background advertisement service 200 that combines the content of advertisers and website publishers. Access to the background advertisement service 200 may be provided by one or more web interface 204, 222s. An advertiser 202 can create an account 206, then create one or more background advertisements 208 that will be stored on the background advertisement database 210 before it is generated onto the publishers website for world wide web users to view.

Web publishers 224 may create accounts to display advertisement on their websites to generate revenue from the available advertisers. Website publishers 224 may also create advertisements for storage on the background advertisement database. A variety of campaigns may be created by the advertisers and web publishers through the automated web interface 222. Such a web interface approach allows for a high degree of customization, while providing an automated and efficient interaction between advertisers and web publishers.

Metrics 212 are available to advertisers 202 and web publishers 224 to evaluate the success of their campaigns. Once the background advertisement is viewed by a user the background advertisement system can accurately store the metrics or analytics of the world wide web user onto the advertisers or website publishers web interface. In addition to judging success, the metrics may also be utilized to fine tune or change the campaign. In short the metrics allow for more efficient use advertisement by web publishers.

As shown the background advertisement database 210 may store background advertisements created by both advertisers and website publishers. The background advertisement database may store the unique generated code of each created background advertisement. The generated code may be stored in several formats such as ASP.net, PHP, javascript or the like. In short the generated code is provided in a format so that the web publisher 224 may easily incorporate the background advertisement into his website with a minimum of effort. The code that is typically generated and stored on the database, and then copy/pasted onto the publishers website may be Javascript, or its equivalent.

An advertiser 202 may interact with the advertiser interface 204 to access metrics 212 or to create an account 206. Once an account is created one or more backgrounds may be created 208, and stored on the background advertisement database 210.

A website publisher 224 may interact with a publisher interface 222, which may be similar to the advertiser interface, to communicate metrics to a metrics data base 212. The metrics may be provided to, or read from the metrics database. Metrics may include CTR (click through rate), ROI (return on Investment), clicks, impressions, resolution size, operating system, and the like. The publisher interface 222 may be used to create an account 220 and then provide advertisement parameters 218. The advertisement parameters may be used to select one or more advertisements from the background database 210. Selected advertisements 214 are downloaded and appropriate code generated 216 to be used in producing the background advertisement on the web publisher's website. The code generated is typically provided through the publisher interface to the website publisher.

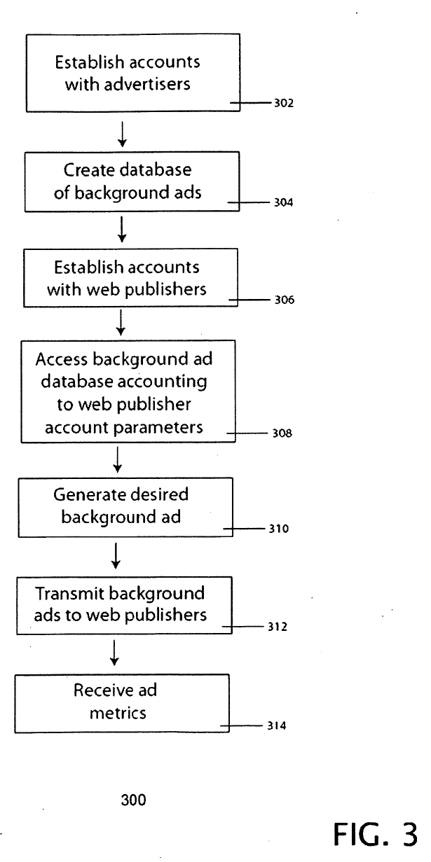

FIG. 3 is a flow diagram of a method of creating a background advertisement campaign. This method can be used both for the website publisher, and the advertiser through the web Interface (advertiser Interface, publisher interface, or combined publisher/advertiser interface). For simplicity's sake when referring to a user who may either be a website publisher, or an advertiser the term client will be used.

The flow diagram shows that a website publisher may first establish an account with the advertiser. This may enable the website publisher to obtain the background assets for the background advertisement. The assets can typically be pictures or graphics in the formats such as .png, .jpg, .gif or .swf or equivalent file types.

Once the background advertisement assets may be entered you can then create the advertisement campaign that will be added and stored on the database in the form of HTML, javascript or other equivalent language. Once a relationship has been established with the website publisher the javascript code can be uniquely generated and the website publisher may copy/paste the javascipt code onto their websites HTML code.

When a world wide web user views the publishers website the javascript code can access the background advertisement database according to the specific website publishers account parameters, in order to generate the desired background advertisement. Once the Transmitted background advertisement is displayed on the publishers website, along with the website publisher's content the background advertisement system will begin receiving advertisement metrics of each unique world wide web user. In particular one or more areas of the background advertisement may be clicked taking the web user to one or more websites of the advertiser.

In particular a campaign 300 may be created by first establishing an account with an advertiser 302. Then a database of background advertisements may be created 304. At block 306 an account may be established with a web publisher 306. At block 308 access to the database of background advertisements according to web publisher parameters or preferences may be provided. At block 310 the background advertisements may be generated. At block 312 one or more background advertisements may be transmitted to the web publisher. In addition to background ads, banner advertisements may also be transmitted to the web publisher for display in conjunction with the background ad. And finally at block 314, the web publisher, and or the advertiser may receive advertisement metrics.

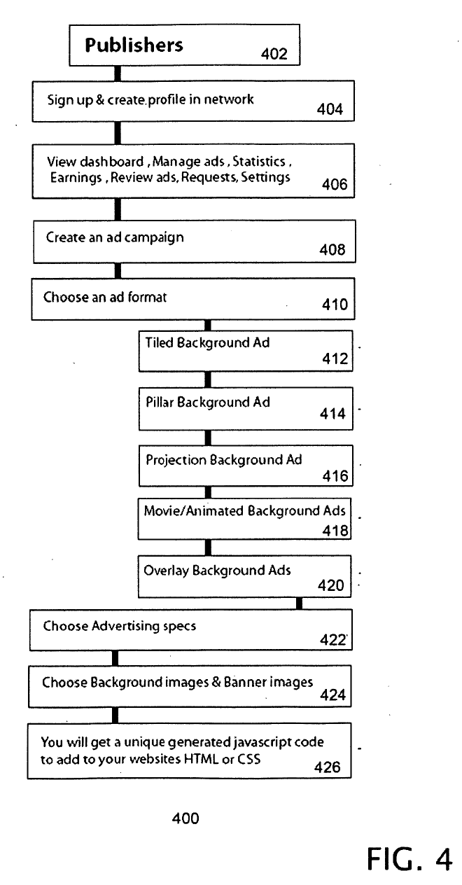

FIG. 4 is a flow diagram of a process for website publishers to create an advertising campaign. The diagram shows that the website publisher can first signup, and once the account is created the website publisher can have further access to the web interface. There may be different sections, or tabs, of the web interface: dashboard, manage ads, statistics, earnings, review ads, create campaigns, requests, account settings and the like.

When the website publisher is in the manage advertisements section the publisher can create a background advertisement campaign or manage existing campaigns. To create a new background advertisement the publisher would first choose the advertisement format for the background campaign. A number of formats, or options, may be created. One or more formats may be based on repeating graphics in one or more patterns. The options may include a tiled background format, pillar background format, projection background format, movie/animated background format (or rich, rich media background format), overlay background format or any other format that may be based on the foundation of background advertisement system.

Once the publisher chooses the desired background format specifications for the advertising campaign may be specified. Which may be the category the background advertisement would be grouped under (for example Auto), the cost model (CPC, CPM, CPA or Flat rate), the dates the background advertisement can run, the date the background advertisement may stop running on, and the like.

Once the advertising specs are filled out the publisher may upload the background ads, or assets, and if there is a corresponding interactive advertising bureau (“AIB”) banner advertisement unit that would be combined with this campaign, then the publisher can upload the assets for it. The file formats will be uploaded in any Image or rich media file format.

Once the background advertisement campaign is finished being created the publisher can review the background campaign for its accuracy then there will be unique generated javascript code that will be shown, and which may be put on the websites HTML or CSS code. If there are more then one background advertisement campaigns, the publisher can create the campaigns in advertisement groups and the publisher can use only one code per website to show multiple advertisement campaigns.

As shown a publisher signs up and creates a profile 404 with the background advertisement service, or network. Once the profile is established the publisher may then view a dashboard display, or equivalent, to manage ads, view or specify statistics, specify or view earnings, review ads, view requests, view and adjust settings, and the like 406. In short anything to manage or otherwise control the campaign may be done from the dashboard. Next the advertisement campaign may be created 408.

At block 410 an advertisement format may be chosen. Formats may include a tiled background advertisement 412, a pillar background advertisement 414, a projection background advertisement 416, a movie and or animated background advertisement 418, overlay background advertisements 420, or the like. Next at block 422 advertising specs may be chosen, and at block 424 background images and banner images may be chosen. And finally unique code, such as exemplary Javascript may be generated to websites typically formatted in HTML, CSS, or the like 426.

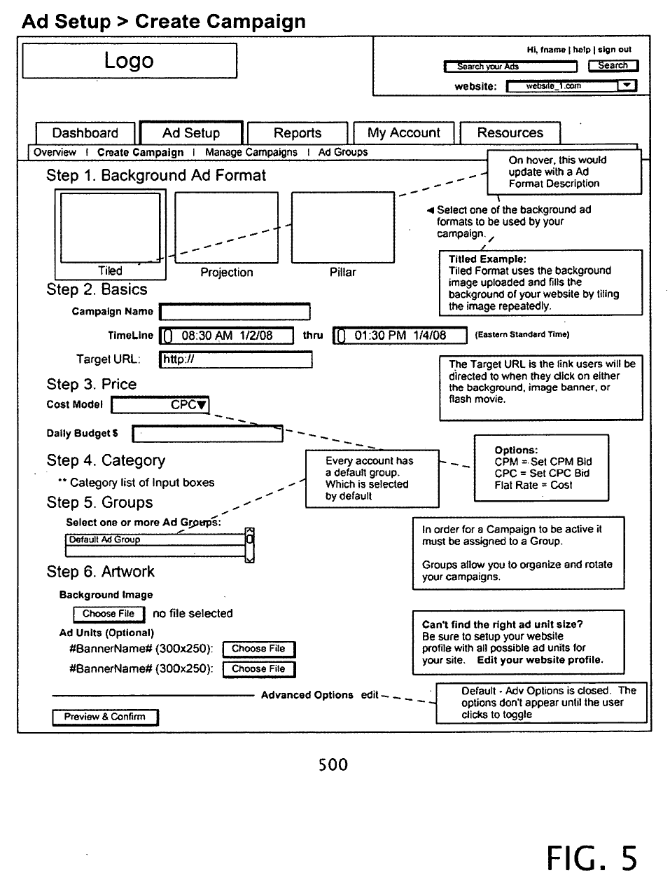

FIG. 5 is an exemplary user interface showing the create campaign tab of the background advertisement service webpage that allows for the setup of the background advertisement. The first action labeled “step 1” can be to select the background advertisement format. There may be Icons provided to choose from Tiled, Projection, Pillar, Rich Media or any other background advertisement formats.

The next action that may be performed labeled “step 2” may be to create a name for the advertisement campaign. The user may also choose the timeline that the advertisement campaign will run from start to finish, typically be selecting start/stop dates, duration, or the like. The user may then type in the Target URL for the link to point to when the background advertisement may be clicked. This is typically the advertising website that a user may be directed to when they click one of the background advertisements displayed with the webpage content. This may be the same link that the corresponding advertisement units can be linked to as well.

Another task labeled “step 3” may be provided to choose the cost model of the background ad. A subscriber may typically be able to choose from CPC, CPM, CPA, or flat rate per day, week or month. Equivalently other criteria may be provided.

The task labeled “step 4” may be choosing the category that the background advertisement campaign best fits under. This selection may aid search, display and to be displayed with similar advertisement campaigns.

The task labeled “step 5” may be provided the option to choose the advertisement group. For this selection the subscriber may pick which group he would like this background advertisement campaign to be displayed with. Advertising Groups may display similar advertisement campaigns in the same rotation.

The task labeled “step 6” may be provided to upload the artwork for the background advertisement along with the artwork for the corresponding AIB advertisement units. The user can upload .jpg, .png, .gif, .swf or any rich media file format.

The custom cursor or brandable cursor selection which may be provided is typically a 32×32 pixel image that the subscriber can upload in cur file format so that when a world wide web user hovers over the background advertisement the cursor will change into the image.

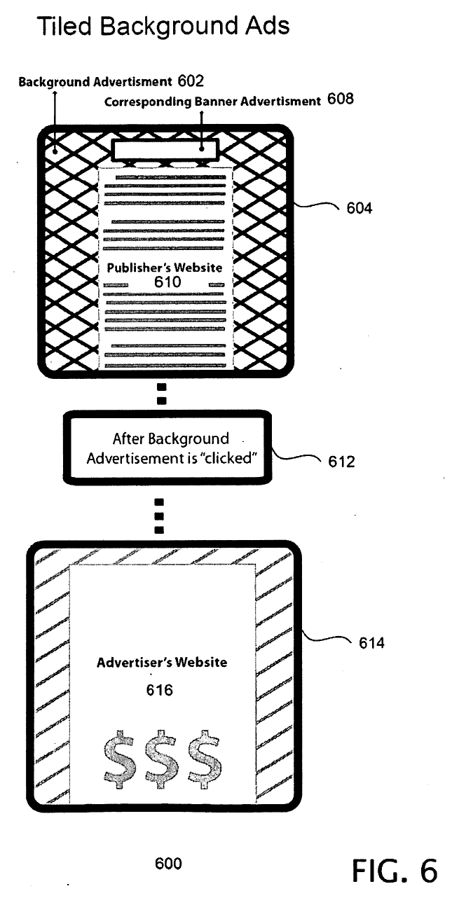

FIG. 6 is the diagram showing an exemplary background advertisement user interface in a tiled background advertisement format 600. The uploaded image can appear in the background 602 of the website tiled in various patterns across the publishers webpage 604, with the optional corresponding AIB standard banner advertisement 608 unit also displayed, typically around the publishers content 610. Each image that is tiled across may be linked to the target url that was added in the create campaign page. When the world wide web user “double clicks” 612 the tiled background image a new window 614 or a new webpage will be opened in the browser window to show the advertisers target URL or website 616. In an alternative example multiple images may be tiled together into a background, and may each be linked to different target urls.

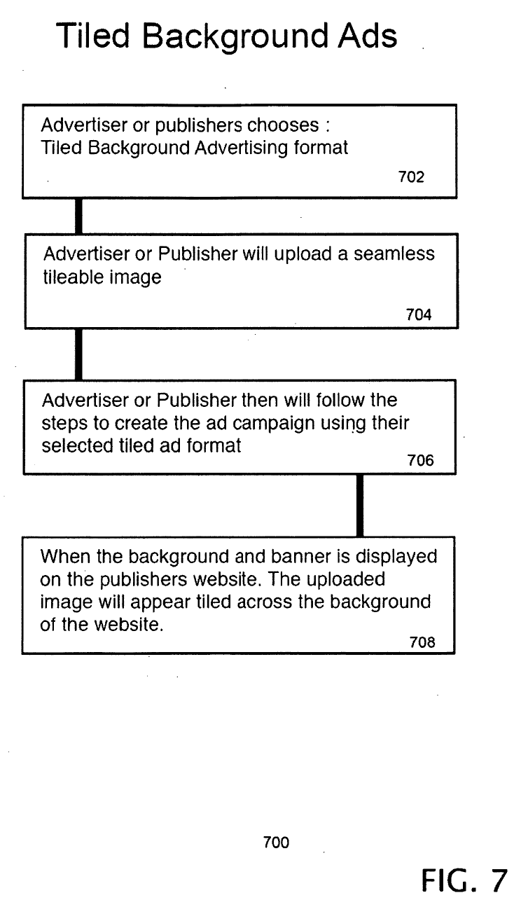

FIG. 7 is the flow diagram showing a process of creation of the tiled background advertisement 700. The advertiser or publisher can choose the tiled background advertisement format 702. The Advertiser or Publisher will upload a graphic that will appear tiled or typically seamless across the background of the publishers website 704. The publisher may then follow the process provided in order to create the advertisement campaign using the selected tiled advertisement format 706. Finally when the background, and/or banner advertisement may be displayed on the publisher's website the uploaded image may appear tiled across the background of the website 708.

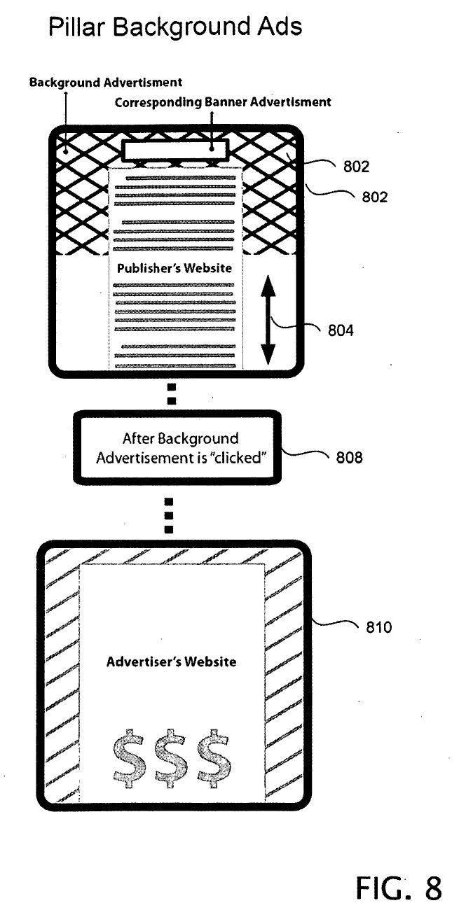

FIG. 8 is the diagram showing an exemplary background advertisement user interface of a pillar background advertisement format 800. The uploaded image will appear at the top, bottom, left or right of the background of the publishers webpage 802. When the world wide web user scrolls 804 the webpage the background will become scrollable with the entire webpage 806. When the background image is “double clicked” 808 a new window or a new webpage 810 will open in the web browsers window to show the advertisers target url or website 810.

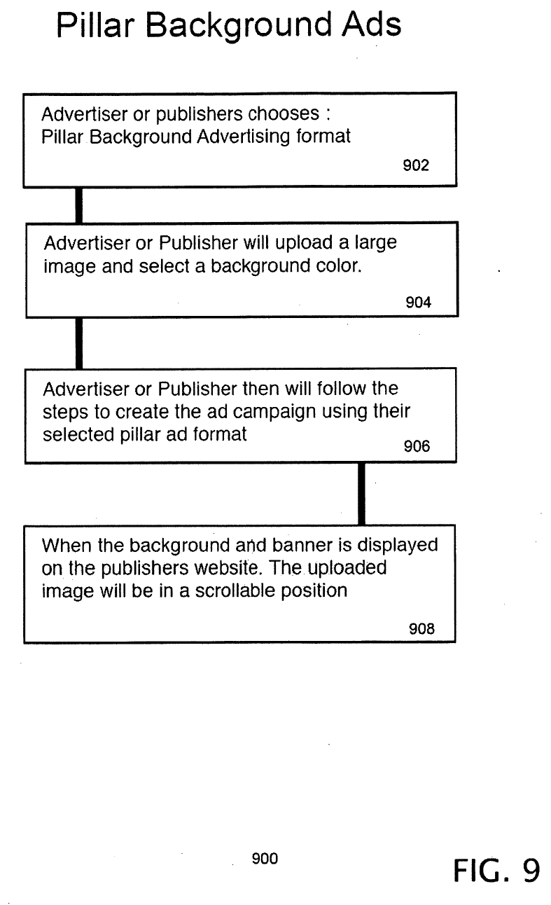

FIG. 9 is the flow diagram showing a process of the creation of the pillar background advertisement 900. The advertiser or publisher can choose the pillar background advertisement format 902. The publisher or advertiser may upload a typically large image and select a background color 904. The advertiser or publisher may then follow the necessary steps in order to create the campaign using their selected pillar advertisement format 906. The advertiser or publisher may then upload a background graphic that will become scrollable with the entire webpage 908.

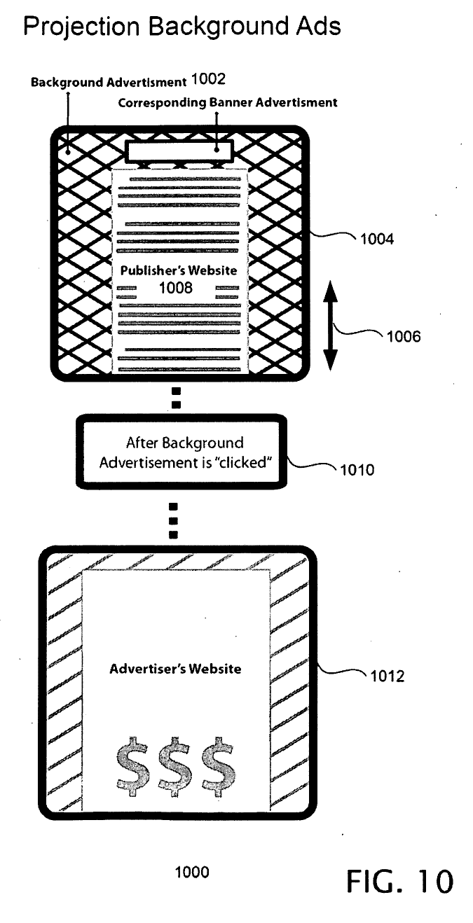

FIG. 10 is a diagram showing an exemplary background advertisement user interface of the projection background advertisement format 1000. The uploaded image 1002 can appear fixed in the background of the publisher's webpage 1004. When the world wide web user scrolls the website 1006 the content of the webpage 1008 will typically be scrolled with the background 1002 typically staying in a fixed position. When the background image is “double clicked” 1010 a new window or a new webpage 1012 may open in the web browser window to show the advertisers target URL webpage.

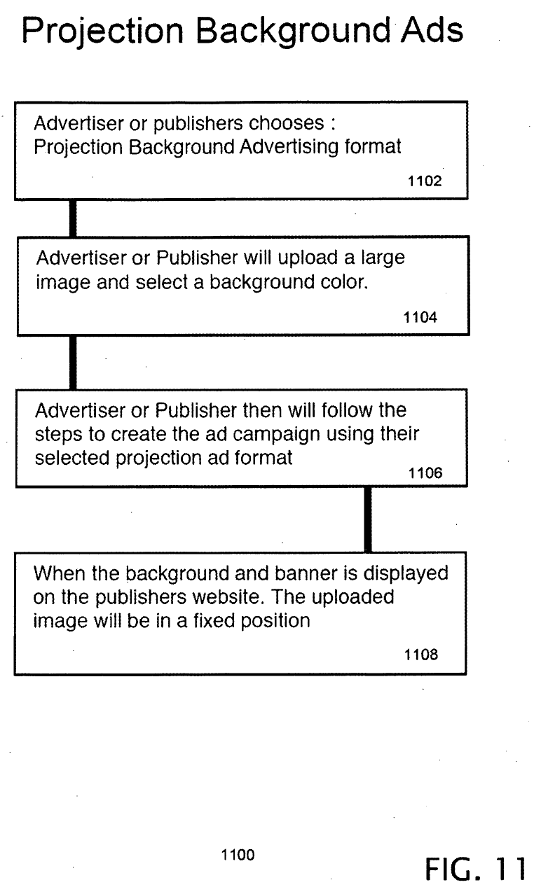

FIG. 11 is a flow diagram showing a process of the creation of the projection background advertisement 1100. The advertiser or publisher will choose the projection background advertisement format 1102. The advertiser or publisher will upload a large image or background graphic and select a background color 1104 that will become fixed positioned in the background of the publishers webpage. The advertiser or publisher may then follow the process to create an advertisement campaign using their selected projection advertisement format 1106. And finally, when the background banner may be displayed on the publisher's website, the uploaded image may be in a fixed position 1108.

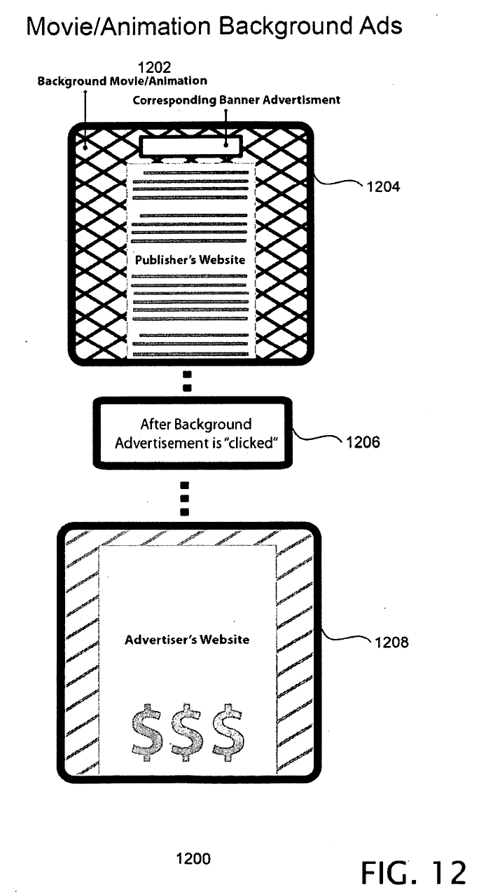

FIG. 12 is a diagram showing an exemplary background advertisement user interface for the display of the movie/animation or rich media background advertisement format 1200. The uploaded rich media file format 1202 can appear fixed in the background of the publishers webpage 1204. The world wide web user can interact with the background. The background can be a shopping cart system, movie, animation or any interactive user experience. When one of the links on the background is “double clicked” 1206 a new window or a new webpage 1208 may open in the web browsers window to show the advertisers target url webpage.

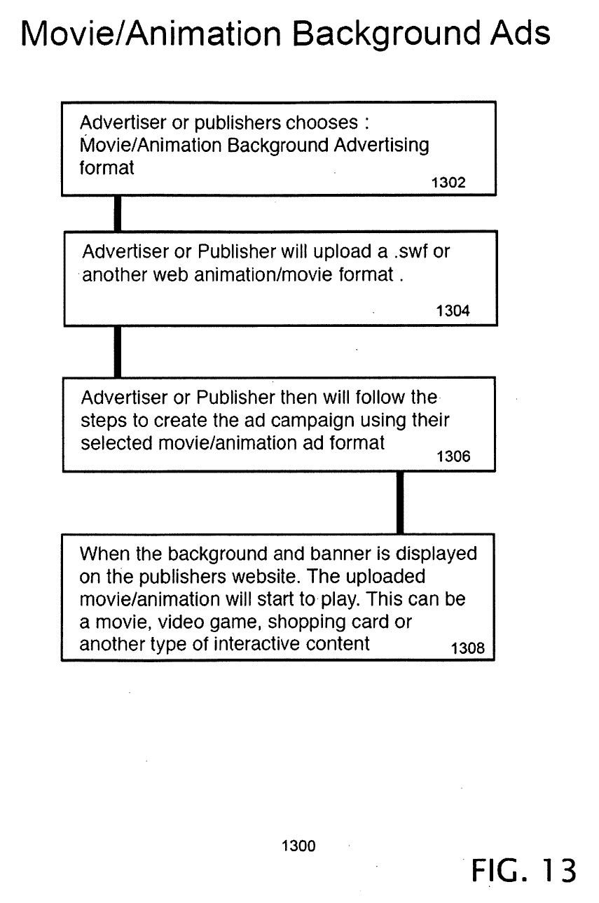

FIG. 13 is a flow diagram showing a process of the creation of the movie/animation or rich media background advertisement 1300. The advertiser or publisher will choose the movie/animation or rich media background advertisement format 1302 and follow the necessary steps in order to create the advertisement. The advertiser or publisher may upload a rich media file format that will become fixed position in the background of the publisher's webpage 1304. The advertiser or publisher may then follow the process to create an advertisement campaign using their selected projection advertisement format 1306. And finally, when the background and banner may be displayed on the publisher's website, the uploaded movie/animation may start to play 1308.

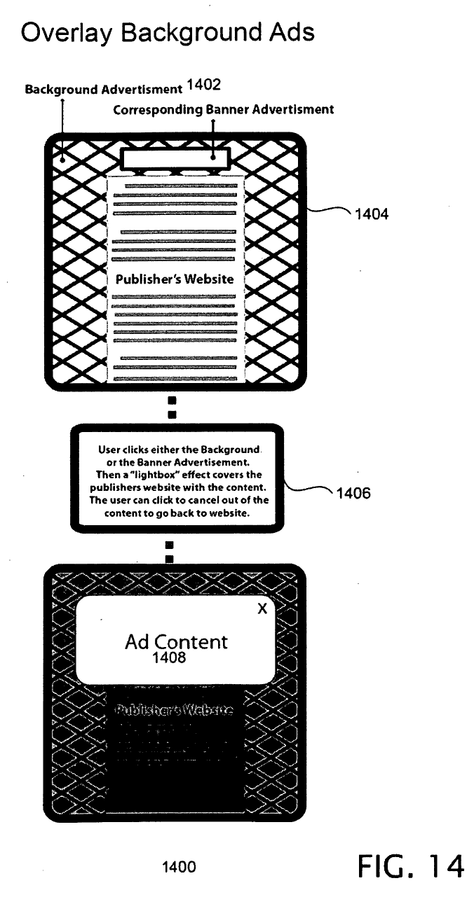

FIG. 14 is a diagram showing an exemplary background advertisement user interface for the display of the overlay background advertisement format 1400. The uploaded rich media or image file format can appear fixed or scrollable in the background 1402 of the publishers webpage 1404. The world wide web user can Interact with the background. Once the background is “double clicked” 1406 in the same browser window a content box will appear using the javascript “light box effect” or similar overlaying display script 1408. The content of the overlay may show a movie, shopping cart, online form or any other content that the publisher or advertiser wishes to add in the creation of the overlay background advertisement format in the create campaign page of the web interface.

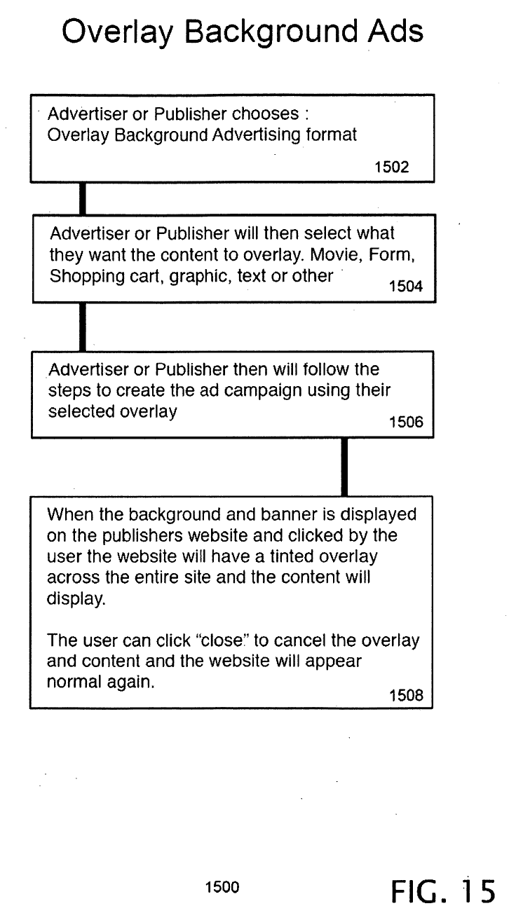

FIG. 15 is a flow diagram showing a process of the creation of the overlay background advertisement 1500. The advertiser or publisher will choose the overlay background advertisement format 1502 and follow the necessary steps in order to create the background advertisement. The advertiser or publisher will upload a rich media file format or image file format for the background along with the content fields for the overlay window that will appear when the world wide web user “double clicks” on the background of the publishers webpage 1504. The advertisement campaign may be created next 1506. And finally the background and banner may be displayed such that they have a tinted overlay across the sight, with the content displayed, with the user being able to cancel the overlay by clicking on it 1508.

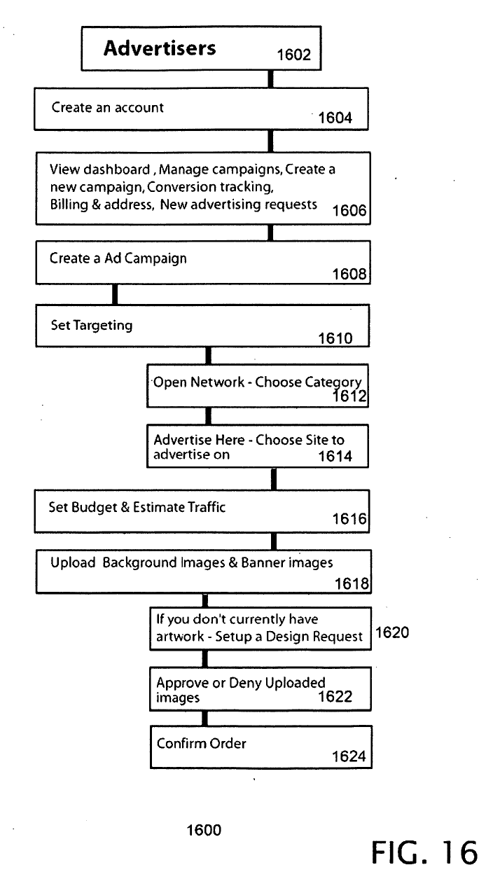

FIG. 16 is a flow diagram of the Advertisers Create Campaign page 600 in the web interface. Advertisers first create an account 1604 in order to log into the web interface. In the web interface advertisers can view their dashboard, manage existing background advertising campaigns, conversion tracking, background advertising metrics and account settings 1606.

Advertisers can first create a background advertising campaign 1608 by first selecting the targeting of the campaign with the proper category selected. Advertisers can also choose the Website Publishers site that they wish to run the background advertising campaign on 1610, 1612, 1614.

Advertisers will set the budget with the estimated traffic and cost model of the background advertising campaign 1616. Next uploading the background images and any corresponding banner ad units may be performed 1618. Advertisers can upload any rich media file format or image file format such as jpg, gif, png or swf. When the background ad campaign is submitted the advertisers can preview the campaign 1622 to make sure it is accurate before confirming the order 1624. Also if the advertiser does not have artwork, a design request may be provided 1620.

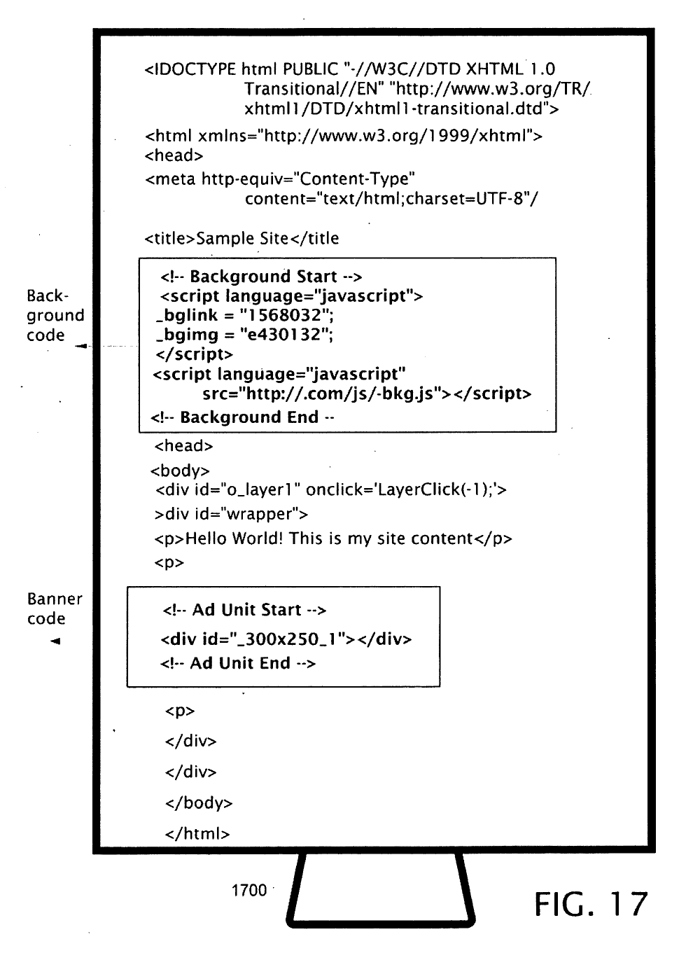

FIG. 17 is a diagram of the exemplary unique website publisher javascript code 1700. This code is typically unique per website, or per ad group that the website publisher may be creating inside the web interface.

The unique background javascript code may be placed anywhere on the website that will sync with any corresponding AIB banner units on the publishers webpage. This code will typically generate all background advertising campaigns in the publisher created ad group.

Each corresponding AIB banner advertising unit may get its own unique javascript code that will display the banner ad units on the publishers webpage when any world wide web user views the publishers website.

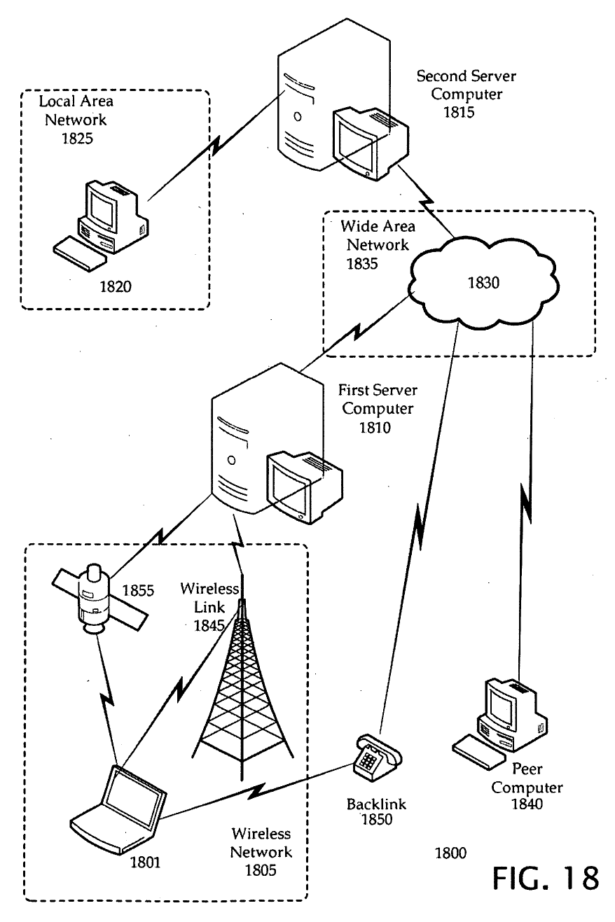

FIG. 18 is an exemplary network suitable for implementing a background advertisement service 1800. Computer 1815 may be a server computer, such as that for hosting a background advertisement service, coupled to a user's computer 1820 through a conventionally constructed local area network 1825.

In the local area network the users computer is typically part of the local area network 1825 which may include a plurality conventional computers (not shown) and conventional peripheral equipment (not shown) coupled together utilizing topologies (token, star and the like) and switching equipment known to those skilled in the art. Those skilled in the art will realize that other processor equipped devices such as televisions and VCRs with electronic program guides, cellular telephones, appliances and the like may be coupled to the internet utilizing conventional techniques known to those skilled in the art.

A typical local area network 1825 may include a conventionally constructed ISP network in which a number or plurality of subscribers utilize telephone dial up, ISDN, DSL, cellular telephone, cable modem, or the like connections to couple their computer to one or more server computers 1815 that provide a connection to the world wide web 1835 via the internet 1830.

Wide area network or world wide web 1835 is conventionally constructed and may include the internet 1830 or equivalent coupling methods for providing a wide area network. As shown a conventionally constructed first server computer 1810 is coupled to conventionally constructed second server computer 1815 through a conventionally constructed internet connection to the world wide web 1830.

In a peer to peer network a peer computer 1840 is conventionally constructed to couple to the internet 183 utilizing peer to peer network technology. Peer computer 1840 may couple to a plurality of similarly connected peer computers in a peer to peer network (not shown), or to other computers 1801, 1820 that are part of conventionally constructed networks 1825, 1835.

In a conventional wireless network 1805 a conventionally constructed computer 1801 is coupled to the internet 1830 via a conventionally constructed wireless link 1845. The wireless link may include cellular, and satellite technology 1855 to provide the link. Such a wireless network may include a conventionally constructed first server computer 1810, typically provided to manage connections to a wide area network such as the internet. Those skilled in the art will realize that the computer 1801 may be embodied as a processor coupled to the electronics of an automobile, and referred to as an automotive processor. Such a processor coupled to the internet may be used to find directions, report trouble or communicate with global positioning systems to determine position.

A conventionally constructed back link may be provided to efficiently provide an additional channel to couple to the internet. For example in situations where communication is one way in nature, the back link may provide communications in the opposite direction. An example would be viewing a listing of available on demand movies and ordering a selection via telephone 1840. Those skilled in the art will realize that back links may equivalently be provided by cellular telephones, cordless telephones, paging devices and the like.

Those skilled in the art will realize that the process sequences described above may be equivalently performed in any order to achieve a desired result. Also, sub-processes may typically be omitted as desired without taking away from the overall functionality of the processes described above.

Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A method of providing background advertisement comprising:
establishing accounts with advertisers;
establishing accounts with website publishers; and
providing background advertisements from the advertisers to the website publishers as uniquely generated code.

2. The method of providing background advertisement of claim 1, in which the code is Javascript.

3. The method of providing background advertisement of claim 1, further comprising creating a database of background ads.

4. The method of providing background advertisement of claim 1, further comprising accessing a background ad database.

5. The method of providing background advertisement of claim 1, in which accessing the background ad database is performed according to website publisher account parameters.

6. The method of providing background advertisement of claim 1, further comprising providing metrics to the advertiser.

7. The method of providing background advertisement of claim 1, further comprising providing metrics to the website publisher.

8. The method of providing background advertisement of claim 1, further comprising providing a corresponding banner advertisement.

9. The method of providing background advertisement of claim 1, in which the banner advertisement is a tiled background advertisement.

10. The method of providing background advertisement of claim 1, in which the background advertisement is a pillar background advertisement.

11. The method of providing background advertisement of claim 1, in which the background advertisement is a projection background advertisement.

12. The method of providing background advertisement of claim 1, in which the background advertisement is a movie background advertisement.

13. The method of providing background advertisement of claim 1, in which the background advertisement is an animation background advertisement.

14. The method of providing background advertisement of claim 1, in which the background advertisement is an overlay background advertisement.

15. A system for providing a background advertisement service comprising:
an advertiser interface
a background advertisement database coupled to the advertiser interface; and
a publisher interface coupled to the advertisement database for receiving a code representing background advertising provided by the advertiser.

16. The system for providing a background advertisement service of claim 15, further comprising providing metrics.

17. The system for providing a background advertisement service of claim 15, further comprising selecting an ad according to parameters supplied by the website publisher.

18. The system for providing a background advertisement service of claim 15, in which the code representing background advertising provided by the advertiser is javascript.

19. A method of generating a advertiser interface display comprising:
generating a display of at least one of a plurality of background advertising formats;
generating a display for selecting a price structure for advertising; and
generating a display for uploading artwork for use in generating a background advertisement.

20. The method of generating a advertiser interface display of claim 19, in which the background advertising formats are graphically displayed.
